(19) United States
(12) Patent Application Publication
(10) Pub. No.: US 2008/0030672 A1
(43) Pub. Date: Feb. 7, 2008

(54) Liquid crystal (LC) alignment system

(75) Inventors: Chin-Yang Lee, Hsinchu (TW); Huang-Chin Tang, Hsinchu (TW); Ying-Fang Chang, Hsinchu (TW); Chen-Der Tsai, Hsinchu (TW); Wen-Tzong Hsieh, Hsinchu (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu Hsien (TW)

(21) Appl. No.: 11/882,651

(22) Filed: Aug. 3, 2007

Related U.S. Application Data
(63) Continuation-in-part of application No. 11/585,833, filed on Oct. 25, 2006.

(30) Foreign Application Priority Data
Aug. 1, 2006 (TW) 095128093

(51) Int. Cl. G02F 1/1337

(52) U.S. Cl. 349/191

(57) ABSTRACT

A liquid crystal (LC) alignment system includes an alignment film having a single or plurality of liquid crystal molecules aligned by a plurality of plasma generating devices, such that the liquid crystal molecules are aligned at a stable pretilt angle. Compared with the prior art, the present invention is suitable for modifying the alignment film surface by adjusting directions and angles of the liquid crystal molecules, and can attain the effect of alignment stability with a pretilt angle in a single process, thus overcoming the drawbacks of the prior art.

### CROSS-REFERENCE TO RELATED APPLICATIONS

This application is a Continuation-In-Part of U.S. patent application Ser. No. 11/585,833, filed Oct. 25, 2006, which claimed priority from Taiwanese application No. 095128093, filed Aug. 1, 2006.

### BACKGROUND OF THE INVENTION

1. Field of the Invention

The present invention relates to a substrate surface alignment technique and, more particularly, to a liquid crystal (LC) alignment system.

2. Description of the Prior Art

With the advances in the Internet and video technology, use of flat panel displays is becoming more important and essential to people's daily life. Unlike conventional CRT panel televisions, liquid crystal displays (LCD) have advantages, such as light, compact, full-color display, radiation-free, digital, high-definition, and power-saving, and thus liquid crystal displays seemingly become the potential mainstream flat panel displays of the next generation.

For liquid crystal displays, the transmission paths and phases of light are altered through the control over the geometric changes of liquid crystals by electric field. With polarizers, liquid crystal displays achieve contrast, which, coupled with driving circuits and color filters, account for the gray scale and colors displayed. In this regard, liquid crystal (LC) alignment technique plays an important, key role in a liquid crystal panel process. The liquid crystal alignment process is not only crucial to the control of the arrangement and alignment of liquid crystals but also indispensable to high-quality display features, such as viewing angle, response time, contrast, and color.

With the advances in the liquid crystal display process technology and the decrease in product costs, it is foreseeable that in the near future liquid crystal display television (LCD TV) will become an information appliance (IA) indispensable to every family. Hence, manufacturers nowadays are devoted to LCD TV research. At present, there are two intractable issues about the liquid crystal displays for use in TV, namely wide viewing angle and short response time.

Major wide-angle technologies in use are, namely Twisted Nematic (TN), Super Twisted Nematic (STN), Multi-domain Vertical Alignment (MVA), and In-Plane Switching (IPS). Unsatisfied with the existing response time, some propose the Optically Compensated Bend (OCB) technique. With the OCB technique, both wide viewing angle and short response time are achievable goals. As regards wide viewing angle, in the presence of an optimized retarder, the viewing angle can be increased to 140° vertically and 160° horizontally, and the response time is less than 7 ms for full gray scale and even less than 3 ms for 15.2″ panel. Besides, inasmuch as the OCB technique enables liquid crystal molecules to be disposed in an arch-shaped pattern, animations with little image sticking can be displayed even at low temperature, and the response time is as short as 40 ms even at a low temperature as low as −20° C., and thus OCB-mode LCD is ten times faster than other types of LCD in terms of low-temperature response time.

Despite its advantages like wide viewing angle and short response time, OCB-mode LCD does have its own drawbacks. For instance, in order to switch an alignment state of liquid crystal molecules from splay alignment to bend alignment, and allow the liquid crystal molecules to continue with the bend alignment without returning to radial alignment, the liquid crystal molecules have to be aligned at different pretilt angles in accordance with their respective compensated angles, and thus splay-bend transition takes place. Owing to the elastic energy of liquid crystal molecules, formation of splay alignment is fast. However, once the bend alignment starts to recur, the pretilt angles of the liquid crystal molecules will become unstable, which is exactly the point where there is the greatest difficulty in mass production based on the OCB technique.

In order to solve the aforesaid problem, related technologies in use involve using a combination of vertical polymer alignment film and horizontal polymer alignment film to fabricate a microstructured surface. In order to solve interface-related problems arising from the combination of two markedly different polymers, the related technologies in use involves providing a substrate 5 formed with a conductive layer 51 and an alignment film 53 as shown in FIG. 7A, and performing an alignment rubbing process on the alignment film 53 with a view to aligning liquid crystal molecules as shown in FIG. 7B, such that the liquid crystal molecules are aligned in the same direction as shown in FIG. 7C.

However, alignment rubbing results in unreliable pretilt angles. In the alignment rubbing process, rubbing of alignment film brings about dust, electrostatic charges, and rubbing defects, thus reducing the yield and the reliability of the process. Hence, there is still room for improvement in the prior art.

For the aforesaid reasons it is highly desirable to develop non-rubbing alignment techniques. Non-rubbing alignment research nowadays is mainly directed to three techniques, namely photoalignment, ion beam alignment, and plasma beam alignment.

Photoalignment is good at homogeneity, but it has technical bottleneck which calls for a breakthrough in such areas as anchoring energy and image sticking. Also, its stability depends on the life of the bulb of the exposure equipment used as well as flashing of a light source.

Ion beam alignment technology requires high-vacuum equipment and electrostatic charge removing equipment and therefore incurs high costs, not to mention that the life of the ion gun used remains an intractable problem. Hence, at the present moment ion beam alignment technology is still limited to laboratories.

Referring to FIG. 8, plasma beam alignment technology involves generating a single plasma beam 61 by a single plasma generating device 6 disposed in a process space, and scanning to and fro an alignment film of a substrate 63 vertically so as to achieve alignment. Although products manufactured by plasma beam alignment technology are almost up to standard, their mass production is faced with such problems as a long process and poor adjustment of direction, because a single plasma generating device has to scan an alignment film to and fro. Besides, scanning back and forth generates vibration that brings about the instability of a process.

Accordingly, an issue calling for urgent solution involves coping with the problems facing the prior art.

### SUMMARY OF THE INVENTION

In light of the aforesaid drawbacks of the prior art, it is a primary objective of the present invention to provide a liquid crystal alignment system so as to stabilize a pretilt angle.

Another objective of the present invention is to provide a liquid crystal alignment system conducive to mass production.

Yet another objective of the present invention is to provide a liquid crystal alignment system conducive to enhancement of process stability.

In order to achieve the above and other objectives, the present invention discloses a liquid crystal alignment system for aligning an alignment film on a substrate. The system comprises a machine equipped with process space; a substrate delivering mechanism disposed in the process space and configured to deliver the substrate to align the align film ; and a plurality of plasma generating devices disposed adjustablely in direction and angle in the process space and respectively arranged opposite to the substrate delivering mechanism for generating plasma beams to modify the alignment film, so as to achieve a stable alignment performance in a single process.

In the aforesaid alignment system, the process space comprises a single chamber or consecutive chambers. The plurality of plasma generating devices generate a plurality of plasma beams. The plasma generating devices are aligned in parallel, in series, or alternately and disposed in the process space. The pressure in the process space is standard atmospheric pressure, vacuum pressure, or ranging from 760 to 1×10⁻⁵ Torr. The plasma generating devices are oriented at from 0° to 90° to the normal of the surface of the substrate. The substrate is perpendicular, tilted at any angle, or rotatable at any angle to the plasma generating devices. Alternatively, the substrate is positioned in a direction selected from the group consisting of horizontal, rotatably horizontal, vertical, and oblique directions. The substrate delivering mechanism concurrently delivers a plurality of substrates so as to align a plurality of alignment films on the plurality of the substrates. The plurality of substrates are parallel or perpendicular to the alignment system, perpendicular or tilted at an angle relative to the plasma beams, or in a direction for the substrates to be parallel to one another or in a direction for forming an angle among the substrates. The plasma generating devices generate plasma sources with the same or different energy levels. The plasma generating devices generate the plasma beams by means of an anode layer, a corona discharge, a plasma glow discharge, a plasma jet, a plasma torch, a surface dielectric barrier discharge, a coplanar diffuse surface discharge, or a ferroelectric discharge. In an embodiment, the substrate delivery mechanisms are disposed around the plasma generating devices. In another embodiment, the plasma generating devices are disposed around the substrate delivery mechanisms.

In yet another embodiment, the plasma beams oriented in adjustable directions and angles are generated by the plasma generating devices so as to modify the alignment film. In a further embodiment, the plasma beams and the substrate are moved relatively to one another, allowing the alignment film to be modified by the plasma beams oriented in adjustable directions and angles. In a further embodiment, the plasma beams are moved unidirectionally, allowing the alignment film on the substrate disposed adjustablely in direction and angle to be modified. In a further embodiment, the plasma beams and the substrate are moved relatively to one another, allowing the alignment film on the substrate disposed adjustablely in direction and angle to be modified.

Compared with the prior art, the present invention discloses a system for fabricating liquid crystal alignment. The system of the present invention provides high-energy plasma beams generated by a plurality of plasma generating devices disposed adjustablely in direction and angle to modify the surface of an alignment film, thus allowing liquid crystal molecules of the alignment film to have a stable pretilt angle ranging from 0° to 90°. Unlike the prior art which is faced with mass production problems arising from its failure to provide thorough and stable bend alignment, the present invention solves the mass production problems. Accordingly, the present invention provides a system for fabricating liquid crystal alignment characterized by a stable pretilt angle.

With a plurality of plasma generating devices (multi-sources) disposed inside a process space, alignment is rapidly achieved by scanning which is performed once only. As a result, the process can be short enough to be conducive to mass production. The prior art is faced with an instability problem arising from vibration generated by a plasma generating device which scans an alignment film back and forth; by contrast, the present invention solves the instability problem and thereby enhances process stability.

### BRIEF DESCRIPTION OF THE DRAWINGS

FIGS. 1A to 1C are schematic views showing an alignment method applied to a liquid crystal alignment system in accordance with the preferred embodiment of the present invention;

FIG. 2 is a schematic view showing a liquid crystal alignment system, and showing how to implement the liquid crystal alignment system;

FIG. 3 is a schematic view showing a substrate and plasma beams aligned in parallel;

FIGS. 4A and 4B are schematic views illustrating the relative positions of substrates and plasma beams in the second preferred embodiment, wherein FIG. 4A shows the substrates joining each other at an angle, and FIG. 4B shows the substrates aligned in parallel;

FIGS. 5A and 5B are schematic views illustrating the relative positions of substrates and plasma beams in the third preferred embodiment, wherein FIG. 5A shows the substrates disposed outside a plasma generating device and delivered at right angle, and FIG. 5B shows the substrates disposed outside a plasma generating device and delivered in a circle;

FIG. 6 is a schematic view showing a liquid crystal alignment system in accordance with the fourth preferred embodiment of the present invention;

FIGS. 7A to 7C (PRIOR ART) are schematic views showing a known liquid crystal alignment system; and

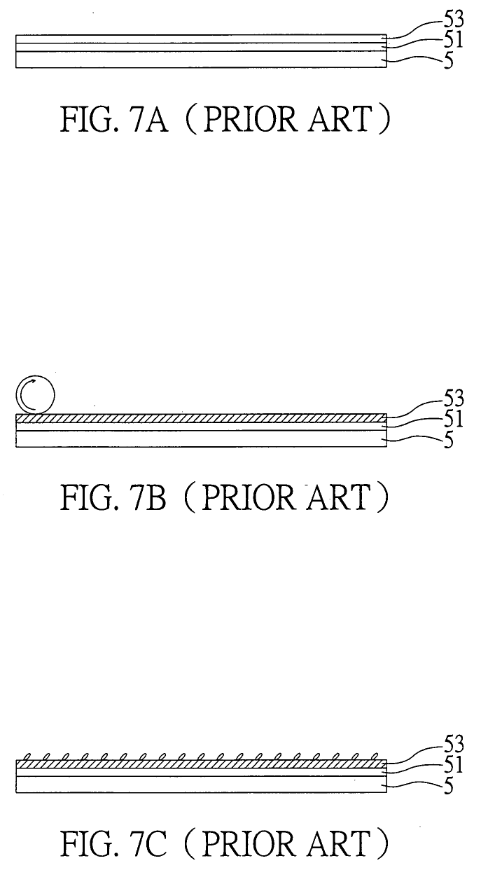

FIG. 8 (PRIOR ART) is a schematic view showing another known liquid crystal alignment system.

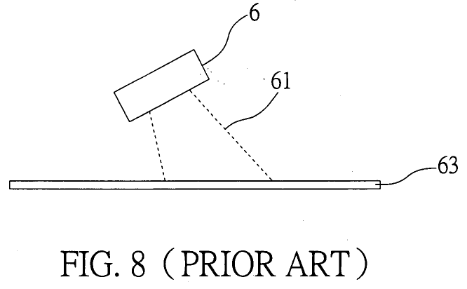

### DETAILED DESCRIPTION OF THE PREFERRED EMBODIMENT

The present invention is herein illustrated with a specific embodiment so that one ordinarily skilled in the pertinent art can easily understand other advantages and effects of the present invention from the disclosure of the invention. In this embodiment, a liquid crystal alignment system and an alignment method applicable thereto are illustrated with liquid crystal displays used in television sets, which is understandably not supposed to limit the present invention. The alignment method which features a pretilt angle may be applied to bistable LCDs and e-book displays. Accordingly, whatever described below regarding the embodiment are merely illustrations exemplary of the present invention.

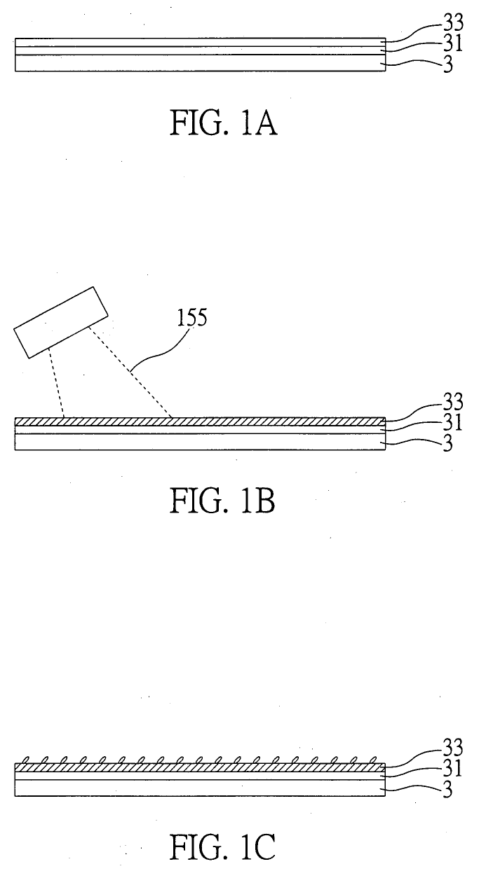

FIGS. 1 to 3 are drawings of the preferred embodiment of the present invention. Referring to FIGS. 1A to 1C, which are schematic views showing an alignment method applied to a liquid crystal alignment system in accordance with the preferred embodiment of the present invention.

Referring to FIG. 1A, a method applied to a liquid crystal alignment system of the present invention comprises the steps of providing a substrate 3, and forming a conductive layer 31 and an alignment film 33 on the substrate 3.

In this embodiment, the substrate 3 is a glass substrate for use in a liquid crystal panel, and the conductive layer 31 is made of indium tin oxide (ITO). In other words, the substrate 3 with the conductive layer 31 disposed thereon is an ITO glass substrate. But the conductive layer 31 is merely one exemplary of its kind, as any other conductive layer applicable to a display can be the alternative. Of course, whoever ordinarily skilled in the art can understand that the substrate 3 with the conductive layer 31 includes, but is not limited to, the glass substrate disclosed in this embodiment, and that substrates with conductive layers made of various materials, such a plastic substrate, a flexible metal substrate, and any appropriate substrate, can be used in any other embodiments.

The alignment film 33 comprises liquid crystal molecules which are aligned, for example, by Vertical Alignment, Twisted Nematic (TN), Super Twisted Nematic (STN), Multi-domain Vertical Alignment (MVA), In-Plane Switching (IPS), Optical Compensated Bend (OCB), Ferroelectric Liquid Crystal (FLC) or any other equivalent means. Insomuch as modification of an alignment film comprising aligned liquid crystal molecules is characterized by easy control of tilt angles (0° to 90°) and photoelectric property of liquid crystal molecules by means of process parameters, this embodiment involves forming on the substrate 3 the alignment film 33 having, for example, vertically aligned liquid crystal molecules.

The alignment film 33 is an organic film, an inorganic film, or an organic-inorganic hybrid film, comprising organic compounds such as polyimide, acrylic, and polyvinyl cinnamate, and inorganic compounds such as glass, quartz, gold, indium tin oxide (ITO), silicon, silicon nitride, hydrogenated amorphous silicon, hydrogenated amorphous carbon (a-C:H), diamond-like carbon (DLC), silicon oxide (SiOₓ), aluminum trioxide (Al₂O₃), cerium dioxide (CeO₂), tin oxide (SnO₂), zinc titanium oxide (ZnTiO₂), and indium titanium oxide (InTiO₂). Depositing the alignment film 33 on the conductive layer 31 of the substrate 3, rubbing alignment, and vertical alignment are techniques which belong to the prior art and thereby are known, and thus they are not herein described in detail.

Referring to FIG. 1B, the alignment film 33 is modified by plasma beams 155 oriented in adjustable directions and angles, such that liquid crystal molecules of the alignment film 33 formed on the substrate 3 are bonded uniformly and regularly and have a stable pretilt angle, as shown in FIG. 1C.

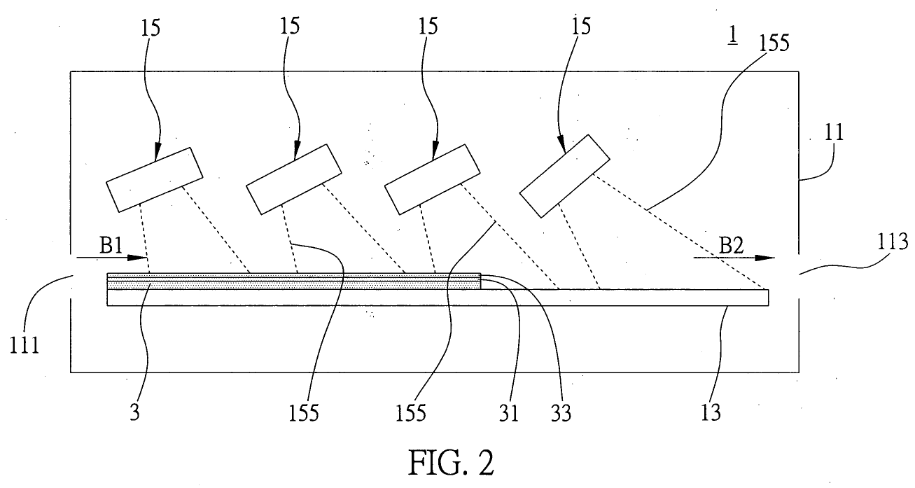

Referring to FIG. 2, an alignment system 1 modifies the surface of the alignment film 33 adjustablely in direction and angle. The alignment system 1 comprises a machine equipped with process space 11, a substrate delivering mechanism 13 disposed in the process space 11, and a plurality of plasma generating devices 15 opposite to the substrate delivering mechanism 13.

The process space 11 comprises a first opening 111 and a second opening 113 opposing to the first opening 111. In this embodiment, the first opening 111 serves as an inlet, and the second opening 113 serves as an outlet. Although in this embodiment the process space 11 of the machine is a single chamber, in any other embodiment the process space 11 can comprise consecutive chambers, that is, a plurality of process spaces 11 communicating with one another, to allow for changes of direction in light of the size of a factory.

The substrate delivering mechanism 13 is disposed beneath the process space 11 and configured to deliver the substrate 3 so as to perform alignment. Considering that the substrate delivering mechanism 13 can be any delivering mechanism designed to convey a substrate, and that related delivering mechanisms are in wide use for industrial purposes, the substrate delivering mechanism 13 is apprehensible to persons ordinarily skilled in the art and therefore is not described herein in detail.

The plasma generating devices 15 for generating plasma beams oriented in adjustable directions and angles (to be described later) are disposed in the process space 11 and aligned above the substrate delivering mechanism 13 with a view to modifying the alignment film 33. In this embodiment, the plasma generating devices 15 are tilted at angles adjustable if necessary and are oriented at from 0° to 90° to the normal of the surface of the substrate 3, such that eventually the liquid crystal molecules of the alignment film 33 are tilted at from 0° to 90°.

The plasma generating devices 15 are with the same or different energy levels and angles, and generate different plasma beams 155, depending on the energy levels. In this embodiment, the outbound plasma beams 155 are supplied by high-energy plasma sources generated by the plasma generating devices 15 at standard atmospheric pressure or in a vacuum (ranging from 760 to 1×10⁻⁵ Torr). The plasma generating devices 15 are tilted at adjustable angles, depending on related functional requirements. More particularly, the plasma generating devices 15 are tilted at angles ranging from 0° to 90° and can be perpendicular, oblique (at any angle), or rotatable (at any angle) relative to the substrate 3, depending on the related functional requirements, rather than solely in the directions or angles specified in this embodiment.

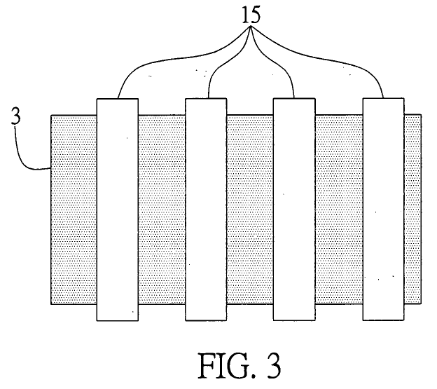

In this embodiment, the plasma generating devices 15 comprise an anode layer, for example. Referring to FIG. 3A, viewing from the substrate 3, the plasma generating devices 15 are arranged in parallel or alternately. In any other embodiment, the plasma generating devices 15 are disposed in the process space 11 and arranged in parallel, in series, or alternately, rather than solely in a way specified in this embodiment.

The outbound plasma beams 155 are supplied by high-energy plasma sources generated by the plasma generating devices 15. In this embodiment, the plasma sources comprise at least two selected from the group consisting of electrons, ions, radicals, and neutral particles. In any other embodiment, the plasma sources comprise one selected from the group consisting of electrons, ions, radicals, and neutral particles. A process gas for generating the plasma sources by the plasma generating devices 15 is, for example, air, dry air, hydrogen, oxygen, nitrogen, argon, steam, helium, and any other gas likely to be ionized and turned into plasma in the aforesaid environment under the aforesaid pressure.

In this embodiment, the process space 11 is subjected to a pressure ranging from 760 to 1×10⁻⁵ Torr, or, in other words, the plasma sources are generated at standard atmospheric pressure or in a vacuum, that is, at pressure ranging from 760 to 1×10⁻⁵ Torr. The plasma generating devices 15 are oriented at from 0° to 90° to the normal of the surface of substrate 3 and then modify the alignment film 33 in adjustable directions and angles, such that eventually the liquid crystal molecules of the alignment film 33 are tilted at from 0° to 90°. Upon plasma-based modification, the surface of the alignment film 33 acquires a stable pretilt angle of from 8° to 10°, allowing optically compensated bend (OCB) crystals to switch from splay mode to bend mode swiftly. Time-dependent decay of alignment of liquid crystal molecules tilted at a great angle (for example, 45° to 55°) is prevented.

Although the alignment system 1 in this embodiment is intended for liquid crystal alignment, the alignment system 1 can also be used for any other industrial purposes associated with mass production, for example, oblique deposition, protective over-coating, substrate cleaning, ion-assisted deposition, optical coating, sputtering processing, PCB cleaning, and thrusters for space technology, provided that process-required plasma beam concentration and divergence angles meet parameter optimization standards and enable maximum treatment efficiency.

The energy levels of the plasma generating devices 15 can be subjected to changes for different purposes, namely liquid crystal alignment, cleaning, deposition, heating, annealing, and surface modification. Plasma divergence angles of the plasma generating devices 15 can be adjusted when necessary, in order to achieve plasma source collimation to different extents. For instance, plasma divergence angles of the plasma generating devices 15 can be adjusted, by altering the structure of the plasma generating devices 15 or by connecting an external device to the plasma generating devices 15.

Compared to the prior art, this embodiment involves moving the substrate 3 unidirectionally and modifying the alignment film 33 by the alignment system 1 disposed adjustablely in direction and angle. As a result, intended alignment quality can be achieved solely by a single process in which the substrate 3 is scanned by the plasma generating devices 15 at a specific speed through adjustment of process parameters, such as vacuity of the process space 11, gas flow (for example, 5 to 100 sccm), distance between the plasma generating devices 15, angle and energy, voltage (for example, 200 to 800 V), pretilt angle, and treatment time (5 to 150 sec). Hence, the present invention shortens a process, speeds up mass production, and enhances process stability. Of course, moving a substrate back and forth can also be a process feature in any other embodiment.

This embodiment involves modifying the alignment film 33 by the plasma generating devices 15 disposed adjustablely in direction and angle, such that liquid crystal molecules of the alignment film 33 formed on a substrate are bonded uniformly and regularly and a stable alignment performance is achieved in a single process. Of course, in order to prevent alignment decay and alignment instability, surface passivation treatment is performed by the introduction of a hydrogen-containing gas during or after the alignment process, as hydrogen atoms saturate the dangling bonds brought about by plasma beams, thus enhancing alignment stability, and keeping unstable chemical bonds in the alignment film intact, thus providing the alignment film 33 with a stable pretilt angle.

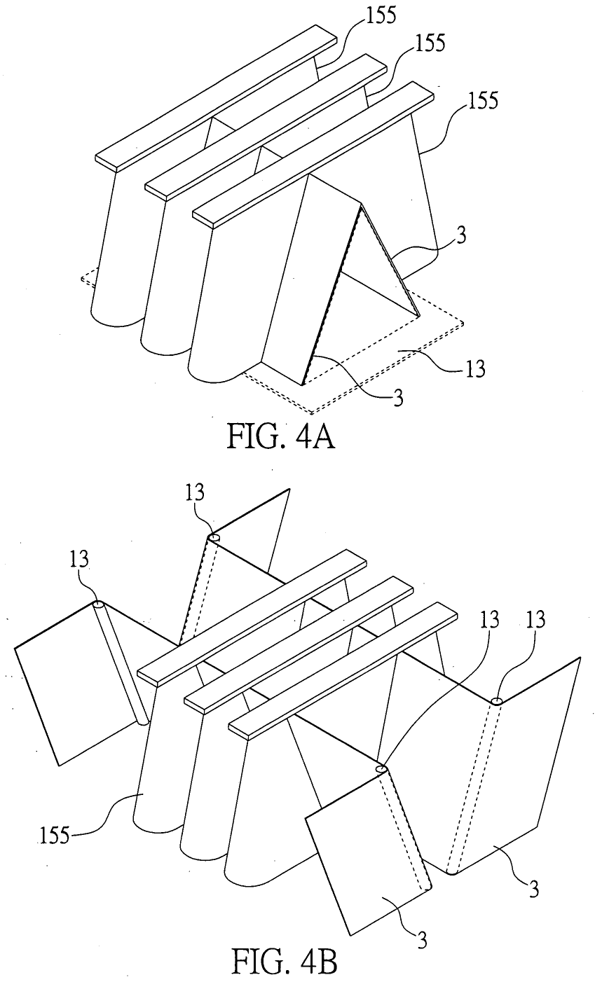

Referring to FIGS. 4A and 4B, which are schematic views illustrating the relative positions of substrates and plasma beams in the second preferred embodiment of, the distinguishing features of the second preferred embodiment are as follows. The substrate delivering mechanisms 13 are capable of delivering a plurality of substrates 3 while concurrently aligning the alignment film 33 of the substrates 3 by means of the plasma beams 155, wherein the substrates 3 may be in parallel to the alignment system, perpendicular to the alignment system, perpendicular to the plasma beams 155, tilting at an angle relative to the plasma beams 155, parallel to one another, or have an angle among the substrates 3.

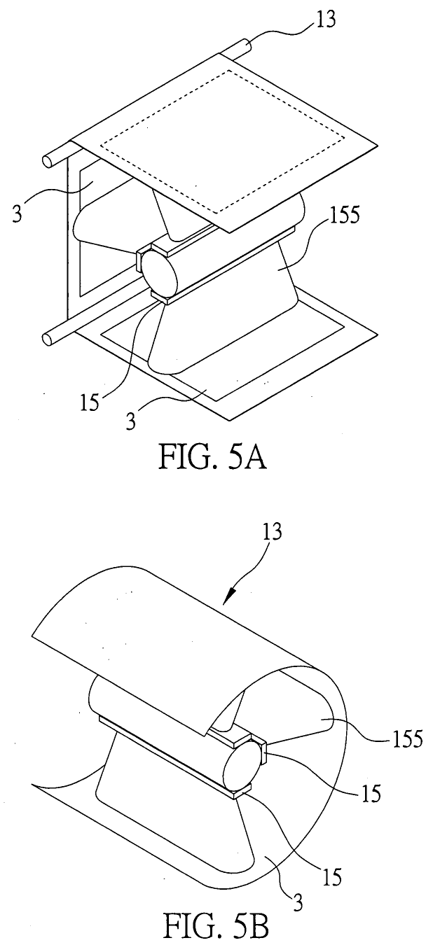

Referring to FIG. 5A, which is a schematic view illustrating the relative positions of substrates and plasma beams of the liquid crystal alignment system in the third preferred embodiment of of the present invention, the distinguishing features of the third preferred embodiment are as follows. The substrate delivering mechanisms 13 deliver the flexible substrates 3 such that the substrates 3 surround the centrally disposed plasma generating devices 15. In other words, in the third preferred embodiment, the plasma beams 155 generated by the centrally disposed plasma generating devices 15 align the peripherally disposed alignment film 33 continuously, and thus delivering the substrates 3 peripherally by the substrate delivering mechanisms 13 is sufficient for alignment of the alignment film 33 to take place. Also, the angles and tilt angles of the plasma beams 155 in the third embodiment can be conveniently adjusted by rotating the plasma beams 155. Referring to FIG. 5B, the substrate delivering mechanisms 13 in the third embodiment can be disposed around, rather than perpendicularly to, the plasma generating devices 15.

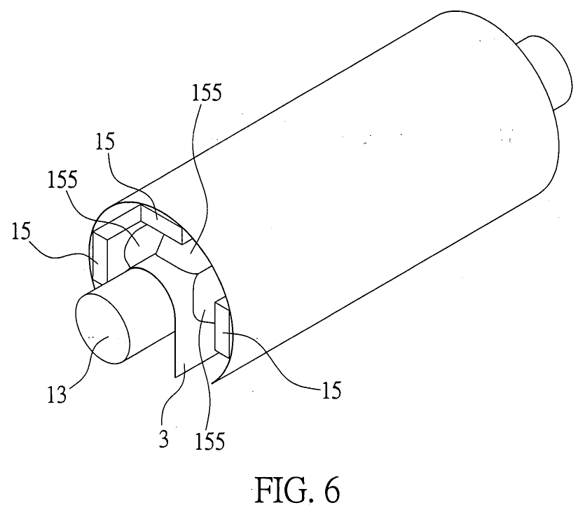

Referring to FIG. 6, which is a schematic view showing the liquid crystal alignment system in accordance with the fourth preferred embodiment of the present invention, the distinguishing features of the fourth preferred embodiment are as follows. The substrate delivering mechanism 13 is an axle, and the flexible substrates 3 are delivered by the outer surface of the axle, thus allowing the alignment film 33 of the delivered substrates 3 to be aligned by the plasma beams 155 generated by the peripherally disposed plasma generating devices 15. In other words, at the axle in the fourth preferred embodiment, the alignment film 33 of the substrates 3 is continuously aligned, and thus the structure of the substrate delivering mechanisms 13 can be made simpler, and therefore machinery miniaturization can be achieved. Also, the tilt angles at which the substrates 3 are disposed can be conveniently adjusted by rotating the axle.

Compared to the prior art, the present invention discloses a liquid crystal alignment system and an alignment method applicable thereto, wherein the method involves modifying the surface of an alignment film by a plurality of plasma generating devices disposed adjustablely in direction and angle, aligning liquid crystal molecules at a stable pretilt angle, such that the liquid crystal molecules of the alignment film are aligned uniformly and regularly and characterized by high anchoring energy and a stable pretilt angle.

Insomuch as the surface of an alignment film is modified by a plurality of plasma generating devices, liquid crystal alignment is achieved in a single process. Hence, unlike the prior art which is faced with problems arising from scanning an alignment film back and forth, the present invention shortens and simplifies a process. In the present invention, liquid crystal alignment is achieved by means of a plurality of plasma generating devices (plasma beams) instead of by rubbing alignment, the present invention has two advantages. First, a stable pretilt angle can be achieved by means of a small amount of energy. Second, stability is enhanced. Accordingly, the present invention solves the problems facing the prior art.

The aforesaid embodiments merely serve as the preferred embodiments of the present invention. They should not be construed as to limit the scope of the present invention in any way. Hence, any other changes can actually be made in the present invention. It will be apparent to those skilled in the art that all equivalent modifications or changes made, without departing from the spirit and the technical concepts disclosed by the present invention, should fall within the scope of the appended claims.

What is claimed is:

1. A liquid crystal (LC) alignment system for aligning an alignment film on a substrate, the system comprising:
a machine equipped with process space;
a substrate delivering mechanism disposed in the process space and configured to deliver the substrate so as to align the alignment film; and
a plurality of plasma generating devices disposed adjustablely in direction and angle in the process space and respectively arranged opposite to the substrate delivering mechanism for generating plasma beams to modify the alignment film so as to achieve a stable alignment performance in a single process.

2. The system of claim 1, wherein the process space comprises one of a single chamber and consecutive chambers.

3. The system of claim 1, wherein the substrate is disposed in a direction selected from the group consisting of horizontal, rotatably horizontal, vertical, and oblique directions.

4. The system of claim 1, wherein the substrate delivering mechanism concurrently delivers a plurality of substrates so as to align a plurality of alignment films on the plurality of substrates.

5. The system of claim 4, wherein the plurality of substrates are disposed in a direction selected from the group consisting of a direction parallel or perpendicular to the alignment system, a direction perpendicular or tilted at an angle relative to the plasma beams, a direction for the substrates to be parallel to one another and a direction for forming an angle among the substrates.

6. The system of claim 1, wherein the substrate delivery mechanism is disposed around the plasma generating devices.

7. The system of claim 1, wherein the plasma generating devices are disposed around the substrate delivery mechanism.

8. The system of claim 1, wherein the plasma generating devices generate plasma sources or ion sources.

9. The system of claim 1, wherein the plasma generating devices are arranged in parallel or in series.

10. The system of claim 1, wherein the process space is of a pressure ranging from standard atmospheric pressure to vacuum pressure.

11. The system of claim 10, wherein the process space is of a pressure ranging from 760 to 1×10⁻⁵ Torr.

12. The system of claim 1, wherein the plasma generating devices are oriented at 0° to 90° to the normal of a surface of the substrate.

13. The system of claim 1, wherein the plasma generating devices generate the plasma beams with identical or different energy levels.
